(19) United States
(12) Patent Application Publication
(10) Pub. No.: US 2024/0210216 A1
(43) Pub. Date: Jun. 27, 2024

(54) SIGNAL PROCESSING DEVICE, ROTARY MEASURING DEVICE, ROTARY MEASURING SYSTEM, AND VEHICLE

(71) Applicant: ZF CV Systems Global GmbH, Bern (CH)

(72) Inventor: Eckard Klotz, Bad Pyrmont (DE)

(21) Appl. No.: 18/600,261

(22) Filed: Mar. 8, 2024

Related U.S. Application Data
(63) Continuation of application No. PCT/EP2022/073012, filed on Aug. 17, 2022.

(30) Foreign Application Priority Data
Sep. 8, 2021 (DE) 10 2021 123 243.0

(51) Int. Cl. G01D 5/244; G01D 21/00; H04L 67/12

(52) U.S. Cl. CPC G01D 5/24457; G01D 21/00; H04L 67/12

(57) ABSTRACT

A signal processing device for a rotary measuring device has a rotary measuring sensor and a rotary scale body having measurement features. The processing device provides chronologically successive message sequences having a message number of successive messages such that chronologically successive messages are assigned to locally adjacent measurement features which chronologically successively interact with the sensor. Each message has a message kind selected from a predetermined number thereof. A message arranged at a selection position is a message of a predetermined kind describing a property of the assigned measurement feature. The successive message sequences have a first and a second message sequence, the processing device selects the selection position for the sequence such that a first position for a first message of a predetermined kind is provided for the first sequence, and a second position for a second message of the same predetermined kind is provided for the second sequence.

### CROSS-REFERENCE TO RELATED APPLICATIONS

This application is a continuation application of international patent application PCT/EP2022/073012, filed Aug. 17, 2022, designating the United States and claiming priority from German application 10 2021 123 243.0, filed Sep. 8, 2021, and the entire content of both applications is incorporated herein by reference.

### TECHNICAL FIELD

The disclosure relates to a signal processing device. The disclosure furthermore relates to a rotary measuring device, a rotary measuring system and a vehicle.

### BACKGROUND

Such a signal processing device is used for signal processing for a rotary measuring device. The rotary measuring device has a rotary measuring sensor and a rotary scale body, wherein the rotary scale body has a feature number of measurement features which are arranged along a circular path and which in particular are arranged equidistantly.

A measurement feature can be configured in various ways depending on the way in which the rotary scale body is constructed. The rotary scale body can have for example a geometric, optical or magnetic material measure in the form of measurement features.

Such rotary measuring devices are generally known, in particular in the field of machines and vehicles. An instantaneous rotary position of a rotating part such as for example, a shaft or a wheel can be determined via a rotary measuring device. Furthermore, direction of rotation, rotational speed and further movement- and/or position-related parameters can be determined via a rotary measuring device. For a rotary measuring device, a wide variety of rotary measuring sensors are known, the sensor principle of which is based on a different measurement principle in each case, for example a magnetic, optical or inductive measurement principle. In the case of a magnetic measurement principle, in particular via a Hall sensor, a voltage change that is characteristic of an instantaneous pose of a scale body relative to the Hall sensor can be output. A Hall sensor advantageously enables a reliable position determination independently of the rotational speed, in particular even if the rotating part is stationary or is rotating relatively slowly.

For signal processing purposes, the signal processing device is configured to provide successive message sequences. The kind of a message sequence can routinely be defined in an assigned data protocol. Data protocols, in particular data sequences, for rotary measuring devices are likewise known. In this regard, a data protocol or a data sequence can generally provide a predefined specification which predefines a scheme of messages in a provided succession, that is, in a so-called message sequence, namely for providing and communicating measurement data of the rotary measuring device.

In this regard, a signal processing device mentioned in the introduction can be configured for outputting message sequences, wherein a message sequence has a message number of successive messages such that chronologically successive messages are assigned to locally adjacent measurement features which chronologically successively interact with the rotary measuring sensor.

The signal processing device mentioned in the introduction is configured for outputting message sequences such that each message is provided in a message kind selected from a predetermined number of message kinds.

The signal processing device mentioned in the introduction is configured for outputting message sequences such that a message arranged at a selection position of the message sequence is a message of a predetermined kind which describes a feature property of the assigned measurement feature.

Rotary measuring devices, rotary measuring systems and signal processing devices, in particular electronic signal processing devices, are furthermore worthy of improvement with regard to the signal processing. In particular, this concerns the lowest possible susceptibility to errors and an improved possibility for diagnostics during the signal processing.

It is therefore desirable to specify an improved signal processing device for a rotary measuring device, and also a rotary measuring device and a rotary measuring system.

### SUMMARY

It is an object of the disclosure to provide, in an improved manner, an electronic signal processing device and a rotary measuring device in which the disadvantages of the prior art are overcome at least in part. In particular, the lowest possible susceptibility to errors and improved possibilities for diagnostics are intended to be made possible.

The object, concerning the signal processing device, is achieved by the disclosure with a signal processing device for a rotary measuring device having a rotary measuring sensor and a rotary scale body having a feature number of measurement features, including: a non-transitory computer readable medium having program code stored thereon; the program code being configured, when executed by a processor, to cause the signal processing device to provide a plurality of chronologically successive message sequences; each of the message sequences having a message number of successive messages such that chronologically successive messages are chronologically successively assigned to locally adjacent measurement features, wherein the measurement features interact with the rotary measuring sensor, and each of the messages is provided in a message kind selected from a predetermined number of message kinds; the message of the successive messages arranged at a selection position of the message sequence being a message of a predetermined kind which describes a feature property of the assigned measurement features; the successive message sequences having a first message sequence and a second message sequence; and, the signal processing device being configured to select the selection position for the message sequences such that a first selection position for a first message of the predetermined kind is provided for the first message sequence, and a second selection position for a second message of the same predetermined kind is provided for the second message sequence.

The disclosure proceeds from a signal processing device for a rotary measuring device, preferably for a vehicle, having a rotary measuring sensor and a rotary scale body, wherein the rotary scale body has a feature number of measurement features, wherein the signal processing device is configured to provide chronologically successive message sequences, and a message sequence has a message number of successive messages such that locally adjacent measurement features are assigned chronologically successively, wherein the measurement features interact with the rotary measuring sensor, and each message is provided in a message kind selected from a predetermined number of message kinds, and a message arranged at a selection position of the message sequence is a message of a predetermined kind which describes a feature property of the assigned measurement feature.

According to the disclosure, in the case of the signal processing device, it is provided that the successive message sequences have a first and a second message sequence, the signal processing device is configured to select the selection position for the message sequence such that a first selection position for a first message of a predetermined kind is provided for the first message sequence, and a second selection position for a second message of the same predetermined kind is provided for the second message sequence.

The “locally adjacent measurement feature” preferably means a “directly adjacent measurement feature”, that is, it generally means the “next feature after a preceding feature in a defined succession of features”. Correspondingly, “chronologically successive messages” preferably means “chronologically directly successive messages” and moreover means the temporal analog—that is, this concerns a message sequence and a measurement feature series in which an element (message/measurement feature) “n+1” follows after a preceding “n”. The background is the tie to a fixed succession or a fixed relationship of an assignment.

Primarily, the assignment is preferably between directly adjacent measurement features and in each case the chronologically directly successive messages. Preferably, therefore, “directly” is primarily intended to mean that “in the succession of measurement features, the next measurement feature [follows] without an intervening measurement feature” and “chronologically directly” is intended to mean the temporal analog in which a message follows the preceding message “without an intervening message”. In a modification, possibly between two elements (message/measurement feature) there may be another element (possibly situated there without being used); however, the tie to a fixed succession or a fixed relationship of an assignment between adjacent measurement features and in each case the chronologically successive messages remains.

Put briefly this is thus taken to mean that a message sequence has a message number of successive messages such that chronologically successive messages are assigned to locally adjacent measurement features which chronologically successively interact with the rotary measuring sensor.

By virtue of the fact that a first selection position for the first message of a predetermined kind is provided for the first message sequence, and a second selection position for a second message of the same predetermined kind is provided for the second message sequence, a selection position specific to the first message sequence and to the second message sequence is advantageously provided. In this way, when there are different message sequences, the message of the same predetermined kind can advantageously be arranged at a respective different selection position.

Since the message of a predetermined kind which describes a feature property of the assigned measurement feature is arranged at the selection position, the arrangement—changing with different message sequences—of the selection position results in a changing detection of measurement features with regard to the feature property.

This advantageously results in a detection of measurement features with regard to the feature property which is independent of a relationship between feature number and message number. In particular, it is advantageously possible to prevent individual measurement features from always being recurrently skipped during each rotation of the rotary scale body. An improved detection of measurement features with regard to the feature property is achieved, in particular in regard to the completeness of the detection of the measurement features of a rotary scale body. As a result, it is possible to improve the diagnostics, in particular error detection, in the rotary measuring device.

In a second aspect, the disclosure presents a rotary measuring device for a rotating part, preferably for a vehicle, particularly preferably for a shaft or a wheel of a vehicle, having: a rotary measuring sensor having a measurement value pickup, a rotary scale body having a feature number of measurement features, in particular wherein the measurement features are arranged along a circular path and/or equidistantly, and a signal processing device in accordance with the first aspect of the disclosure, which is connected to the measurement value pickup in a signal-carrying manner. Advantageously, the signal processing device is integrated into the rotary measuring sensor, particularly advantageously accommodated together with the measurement value pickup in a housing.

In a third aspect, the disclosure presents a rotary measuring system, preferably for a vehicle, having at least one rotary measuring device in accordance with the second aspect of the disclosure, and an assignment unit configured to assign the message of a predetermined kind arranged at a selection position of the message sequence, in particular a status message of a message sequence, to a measurement feature.

In a fourth aspect, the disclosure presents a vehicle, having a rotary measuring device, in particular for a shaft or a wheel of the vehicle, in accordance with the second aspect of the disclosure.

A rotary measuring device in accordance with the second aspect or a rotary measuring system in accordance with the third aspect of the disclosure can particularly advantageously be used in a vehicle since a lower susceptibility to errors and/or an improved possibility for diagnostics of the rotary measuring device are/is achieved in an improved manner by the signal processing device in accordance with the first aspect of the disclosure. In particular, the safety and reliability of the vehicle can advantageously be increased as a result.

In accordance with a fifth aspect of the disclosure, a method is provided for signal processing for a rotary measuring device including a rotary measuring sensor and a rotary scale body, wherein the rotary scale body has a feature number of measurement features, wherein the method for signal processing has the step of: providing chronologically successive message sequences, wherein a message sequence has a message number of successive messages such that chronologically successive messages are assigned to locally adjacent measurement features which chronologically successively interact with the rotary measuring sensor, and each message is provided in a message kind selected from a predetermined number of message kinds, and a message arranged at a selection position of the message sequence is a message of a predetermined kind which describes a feature property of the assigned measurement feature.

In the method in accordance with the fifth aspect, it is provided that the successive message sequences have a first and a second message sequence. In the method in accordance with the fifth aspect, the following step is provided: selecting the selection position for the message sequence such that a first selection position for a first message of a predetermined kind is provided for the first message sequence, and a second selection position for a second message of the same predetermined kind is provided for the second message sequence.

The method is advantageously configured in the form of a computer-implemented method, including the steps of the method for signal processing.

In accordance with a sixth aspect of the disclosure, a computer program product is provided, wherein the computer program product includes instructions which, when the program is executed by a computer or suchlike electronic control unit (ECU), particularly advantageously in the context of a computing and data processing device, cause the latter to carry out the steps of the method according to the fifth aspect.

It should also be understood that the signal processing device, preferably with an assigned data protocol, in accordance with the first aspect of the disclosure, the rotary measuring device in accordance with the second aspect of the disclosure, the rotary measuring system in accordance with the third aspect of the disclosure and the vehicle in accordance with the fourth aspect, the method in accordance with the fourth aspect of the disclosure and the computer program product in accordance with the fifth aspect of the disclosure have identical and similar sub-aspects of the disclosure. In this respect, for the development of one aspect of the disclosure, reference is also made to the developments of the other aspects of the disclosure.

A measurement feature is advantageously formed by properties of the rotary scale body, in particular by the geometric, optical or magnetic properties of the rotary scale body. Besides the detection of a continuous measurement signal describing the instantaneous rotary position of the rotating part, it has proved to be advantageous to define measurement features by way of characteristic, in particular reliably detectable, locations on the rotary scale body. In this regard, a measurement feature can be arranged at a location of a local maximal or minimal manifestation of the rotary scale body, for example at a location of a locally maximally or minimally manifested magnetization or radial extent (for example, at the maximum of a tooth tip or at the minimum of a tooth valley) or the like. Moreover, a combination is possible, such that a measurement feature is formed by each local maximum and by each local minimum.

Alternatively or additionally, a measurement feature can be formed by other properties of the rotary scale body, advantageously by the location of a local change, in particular maximal change,—generally of a property or a transition between properties—of the rotary scale body.

Such a location can be formed for example by a tooth flank at a transition from a tooth tip to a tooth valley, or by a transition between two magnetic poles. It should therefore be understood that one or more measurement features can be assigned to a material measure on the rotary scale body, for example a tooth or a tooth-valley pairing or a magnetic pole.

In an embodiment—which is also described in greater detail in relation to the embodiments as a pole wheel (referred to as target)—a rotary scale body can be realized as a pole wheel (referred to as target). Nevertheless, a wide variety of realization variants of these or other embodiments are possible, for example, as a toothed or perforated wheel or a magnetized wheel, for instance in the form of a drum, disk or the like. Reference made here in some instances to a pole wheel (referred to as target) as an embodiment should on no account be understood to be restrictive in this respect, but rather to be by way of example for elucidating a general principle.

A data protocol is understood to be a specification regarding the order of messages that are provided by the signal processing device or the rotary measuring device. The data protocol can thus serve merely for defining a data sequence. In developments, the data protocol can include further specifications, for example for defining the length and/or the encoding of individual messages.

Advantageously, the first selection position is different than the second selection position. Advantageously, the signal processing device has a selection module for selecting the selection position.

In the context of an embodiment, it is provided that the signal processing device and/or the selection module are/is configured to select a selection position for each message sequence. In such a development, advantageously for each message sequence a selection position, in particular different than the previous message sequence, for an advantageously changing assignment is implemented.

In the context of an embodiment, it is provided that the message of a predetermined kind is a status message, in particular a peak-to-peak message describing an amplitude of a local measurement signal change of the rotary measuring sensor, or a temperature message describing a temperature at the rotary measuring sensor. A status message advantageously describes a property of the measurement feature in a manner that is standardized in accordance with a data protocol. A status message is advantageously configured as a peak-to-peak message or as a temperature message according to the nature of an AK protocol, in particular one of version 4.0. Via a temperature message, it is advantageously possible to detect temperature increases that allow a conclusion to be drawn for example about the evolution of heat at the scale body or sensor or surrounding components such as brakes or wheels. Such a temperature increase makes it possible to deduce an irregularity or possible damage that can advantageously be detected via a temperature message.

In the context of an embodiment, it is provided that the signal processing device is configured to recognize a message kind of the message on the basis of a property identifier, which is preferably formed by two message bits of each message, particularly preferably formed by the first two message bits of each message. In particular, the signal processing device has an identification unit for such recognition of the message kind. The meaning of each message can be determined by such recognition of the message kind, advantageously with relatively low processing complexity.

In the context of an embodiment, it is provided that the signal processing device is configured to select a selection position as a function of a revolution of the rotary scale body and/or of the message sequence. This can include in particular the fact that with each revolution of the rotary scale body, the determination of the selection position takes place in a new manner, in particular exactly one selection position is defined anew.

Advantageously, it is provided that the signal processing device is configured to provide a selection position for each revolution number of revolutions of the rotary scale body or for each sequence number of message sequences, wherein the first selection position and the second selection position are part of an integral number series. This can advantageously include the fact that a selection position is provided depending on a number series and in particular also depending on the preceding revolutions and/or message sequences. The provision or definition of the selection position is thus a function of the revolution and/or the message sequence, particularly preferably a function of the revolution number and/or the sequence number.

Advantageously, it is provided that the signal processing device is configured to adapt the number series by an integral amount, advantageously to add the integral amount, for each revolution number and/or sequence number. Such an, in particular additive, alteration of the number series enables the selection position to be effectively adapted with relatively low computational complexity. Advantageously, it is provided that the signal processing device is configured to provide a sequence position ascending integrally with each revolution number and/or sequence number as selection position.

Advantageously, it is provided that the signal processing device is configured to select a randomly generated random number as the selection position, wherein a first random number is generated for the first selection position and a second random number is generated for the second selection position, and the random number can assume an integral value between the value zero and the value of the message number. Such a generation of the selection position is advantageously particularly insusceptible vis-à-vis possible unwanted repeated assignments of messages of a predetermined kind to measurement features. Such unwanted assignments could occur for example as a result of specific configurations of message number, feature number and selection position.

In the context of an embodiment, it is provided that the message sequence includes a message of a predetermined kind of a first type with a selection position of a first position type and a second message of a predetermined kind of a second type with a second selection position of a second position type. In such a development, it is advantageously possible to detect different feature properties in a message sequence. Advantageously, the message of a predetermined kind of a first type can be a peak-to-peak message and the message of a predetermined kind of a second type can be a temperature message. Nevertheless, other assignments of messages of a predetermined kind are also possible.

Advantageously, it is provided that the selection position of a second position type is arranged at the last sequence position of each message sequence, wherein the second message of a predetermined kind advantageously indicates the end of the message sequence on the basis of a property identifier. In such a development, via the second message of a predetermined kind, it is advantageously possible both to indicate the end of a message sequence and to describe a message property.

In the context of an embodiment, provision is made of an encoding unit configured for encoding and/or decoding information, preferably index information and/or useful information. Preferably, the index information IX describes an information category, particularly preferably a fault kind or a manufacturer indication for a hardware version or a software version.

Preferably, the encoding is effected by the arrangement of at least one message of a predetermined kind, preferably a temperature message, at a sequence position in a message sequence. Preferably, the signal processing device is configured to provide both message sequences in the form of row change sequences with a first message number, and message sequences in the form of row intermediate sequences with a second message number. Particularly preferably, the signal processing device is configured to provide a row change sequence, followed by an intermediate sequence number of row intermediate sequences. Preferably, index information IX is encoded in the row change sequence. Preferably, useful information IY is encoded in the row intermediate sequence.

Preferably, the second message number is such that a feature number of an assigned rotary scale body is integrally divisible by the second message number. Preferably, a message sequence has one or more sequence sections, wherein a message of a predetermined kind, preferably a temperature message, can in each case be arranged at a sequence position within the sequence section for the purpose of encoding and/or decoding. Preferably, the first message number is different than the second message number, particularly preferably greater than the second message number by the value 1.

Preferably, the intermediate sequence number is equal to a number of X−1, where X is the integral quotient of the feature number and the second message number. Preferably, per message sequence, in particular per row change sequence and/or per row intermediate sequence, at least one sequence section including a plurality of sequence positions is provided, in which a message of a predetermined kind, in particular a temperature message, can be arranged for the purpose of encoding.

In the context of an embodiment of the rotary measuring device, it is provided that the rotary scale body is configured as a toothed wheel, in particular a measurement feature is configured as in each case a tooth tip and in each case a tooth valley, or in each case as a tooth-valley pairing including a tooth tip and a tooth valley. Preferably, the rotary scale body has a feature number of 60 or 80 or 100 or 120 measurement features. The feature number can differ in other developments.

Preferably, the electronic signal processing device or the rotary measuring sensor has an evaluation unit configured for providing the data protocol in accordance with the first aspect of the disclosure depending on a measurement voltage of the rotary measuring sensor.

In the context of an embodiment of the rotary measuring device or the rotary measuring system, it is provided that the assignment is given in the form of a value tuple, on the basis of the message number, preferably according to an assigned data protocol.

In the context of an embodiment of the rotary measuring system, an assignment unit is configured to assign a message of a predetermined kind of a message sequence to a measurement feature in the form of a value tuple, in particular on the basis of the message number. For the purpose of assignment to a measurement feature, a feature index, in particular in the form of an integral numbering, can advantageously be assigned to each measurement feature. Advantageously, the value tuple can include further components, in particular an index for assigning the value tuple in a table.

In the context of an embodiment of the rotary measuring system, provision is made of an assignment memory, in particular an assignment table, which is configured to store in each case an assigned message of a predetermined kind, in particular the value tuple, for one or more measurement features. The assignment memory can be formed by a database, a flash memory or suchlike suitable storage means.

In the context of an embodiment of the rotary measuring system, provision is made of a diagnostic unit, configured for recognizing a fault state and/or an operating state depending on the at least one measurement feature assigned to the message of a predetermined kind, in particular depending on the at least one value tuple. The diagnostic unit can be formed as a software module, in particular in the electronic control unit, or as a hardware module.

In an embodiment, the rotary measuring system has an electronic control unit (ECU), which is realized particularly advantageously in the context of a computing and data processing device. The signal processing device and/or the electronic control unit (ECU) can advantageously be a microcontroller; for example an ASIC chip (referred to as application-specific integrated circuit, ASIC, also Custom Chip).

Advantageously, the signal processing device and/or the electronic control unit (ECU) have/has a communication interface, for example an antenna or suchlike wireless communication interface to the measurement value pickup. The measurement value pickup of the rotary measuring sensor is assigned to the rotary scale body for the purpose of detecting measurement features, in particular for the purpose of detecting the measurement features in conjunction with a rotating movement of the rotary scale body. The electronic control unit can advantageously include an assignment unit and/or an assignment memory and/or a diagnostic unit.

### BRIEF DESCRIPTION OF DRAWINGS

The invention will now be described with reference to the drawings wherein:

FIG. 1 shows a schematically illustrated preferred embodiment of a rotary measuring device in accordance with the second aspect of the disclosure, with a signal processing device in accordance with the first aspect of the disclosure, which is configured for providing successive message sequences in accordance with a data sequence;

FIG. 2 shows a data protocol, in particular a data sequence, for preferred embodiments of a signal processing device in accordance with the first aspect of the disclosure;

FIG. 3A, FIG. 3B, FIG. 3C, FIG. 3D each show preferred embodiments of a data allocation schedule as a possible form of the provision of message sequences;

FIG. 4 shows a further possible form of the provision of selection positions via random numbers for a further preferred embodiment of a signal processing device;

FIG. 5 shows a schematic illustration of a preferred assignment memory with an assignment table for assigning a message number of status messages in each case to a measurement feature;

FIG. 6 shows a schematic construction of a message with message bits;

FIG. 7A shows a perspective view of a preferred embodiment of a rotary measuring device in accordance with the second aspect of the disclosure;

FIG. 7B shows a perspective view of a further preferred rotary scale body configured as a crown wheel; and,

FIG. 8 shows a schematically illustrated preferred embodiment of a vehicle in accordance with the third aspect of the disclosure, having a rotary measuring system in accordance with the third aspect of the disclosure.

### DETAILED DESCRIPTION

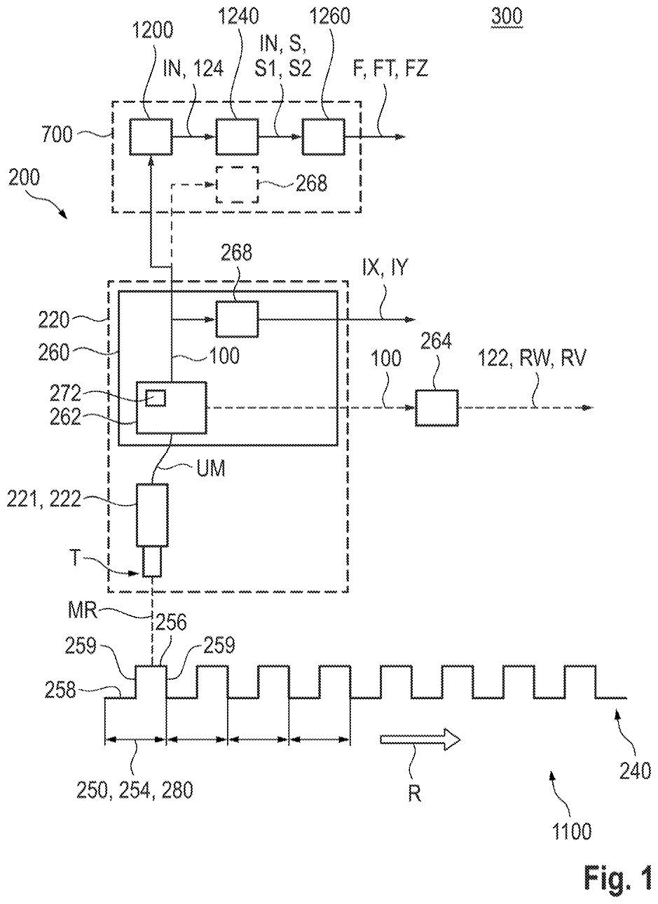

FIG. 1 shows a schematically illustrated embodiment of a rotary measuring system 300 having a rotary measuring device 200. The rotary measuring device 200 has a rotary measuring sensor 220 and a rotary scale body 240. In the present case, the rotary measuring sensor 220 has a measurement value pickup 221 configured as a Hall sensor 222. The Hall sensor 222 is aligned with the rotary scale body 240, for example a pole wheel, in a measurement direction MR. The rotary scale body 240 is connected to a rotating part 1100, for example a wheel 540 of a vehicle 1000, for conjoint rotation therewith, in order to detect the rotary movement R thereof. The inherently known functioning of a Hall sensor 222 is described in a simplified way such that depending on the presence of a measurement feature 250 in the measurement field—described here in a simplified way by the measurement direction MR—of the Hall sensor 222, an induced measurement voltage UM is provided by the Hall sensor 222.

By way of example, when a tooth tip 256 is present on a pole wheel, as a preferred embodiment of the rotary scale body, a higher measurement voltage UM is provided compared with when a tooth valley 258 is present, although this assignment can also deviate, for example depending on the alignment of the Hall sensor 222. Other properties principally of the sensor can also be taken into account, for example primarily a selection of the Hall elements of the Hall sensor 222.

In the present case, a tooth tip 256 and a succeeding tooth valley 258 together form a tooth-valley pairing 254. In the present case, a tooth-valley pairing 254 forms a measurement feature 250.

Nevertheless, as mentioned above for a different embodiment, a different assignment is possible, for example by each tooth flank 259 forming a measurement feature 250. In this case, two measurement features 250 would arise within a tooth-valley pairing 254; namely a first measurement feature for a rising tooth flank in the direction of rotation and a second measurement feature for a falling tooth flank in the direction of rotation.

In the present case, the rotary measuring device 200 furthermore has an electronic signal processing device 260 configured for providing a data protocol 100. In the present case, the signal processing device 260 is integrated in the rotary measuring sensor 220 and is connected to the measurement value pickup 221 in a signal-carrying manner. In other embodiments, the signal processing device 260 can also be embodied in other electronic components. In other embodiments, the signal processing device 260 can be embodied for example as a hardware or software module in a superordinate, in particular central, electronic control unit 700, for example a vehicle control unit 702. In the present case, the signal processing device 260 has an evaluation unit 262. Advantageously, as shown here, the evaluation unit 262 can have an identification unit 272 configured for ascertaining the message kind NT of each message 120. Preferably, the identification unit 272 is configured to ascertain the message kind NT on the basis of at least one message bit 178 of a message 120, preferably on the basis of a property identifier 180 of the message 120.

The rotary measuring system 300 has an assignment unit 1200, an assignment memory 1240 and a diagnostic unit 1260, which are arranged in an electronic control unit 700. The signal processing device 260 is configured, depending on the measurement voltage UM of the Hall sensor 222, to provide information in accordance with the data protocol 100, in particular in accordance with a data allocation schedule 1300 or a random number ZZ, specifically with a message 120 for each measurement feature 250 which has passed the rotary measuring sensor 220. The signal processing device 260 or the rotary measuring sensor 220 can advantageously be configured for providing a time stamp for each message 120.

In particular, a message 120 is generated directly after the corresponding measurement feature 250 has passed, and upon reaching the message number A of the message sequence 110, that is, when a quantity of measurement features 250 corresponding to the message number A has passed the rotary measuring sensor 220, the message number A of messages 120 is provided as message sequence 110.

The assignment unit 1200 is configured to detect from the data protocol 100 those messages 120 which are messages of a predetermined kind 123, in particular status messages 124, and to assign them to the respective measurement feature 250. For this purpose, a feature index MIN or a number can advantageously be provided for each measurement feature 250 of the rotary scale body 240. Advantageously, the value tuple can include further components, in particular an index IN for assigning the value tuple. The value triple including feature index MIN, index IN and status message 124, can advantageously be stored in the assignment memory 1240, in particular with an assignment table 1242. For clarification: given an feature number MA of 80, shortly before completion of a third revolution U of the rotary scale body 240, the index IN would be incremented up to 240 (U×MA=3×80). The feature index MIN, which always starts from scratch again in the course of incrementing after reaching the feature number MA, would accordingly be 80 (and would start again at 1 in the case of the next measurement feature at the beginning of the fourth revolution).

Independently of their time of occurrence, preferably their time stamp, messages 120 communicate further information in their so-called “words”, the meaning of which information is dependent, however, on the message kind and on the kind of data protocol. In the context of one preferred embodiment, this can be the AK data protocol mentioned further below, or a data protocol in general.

In this regard, in the “words” of so-called channel messages—depending on the kind of data protocol—“channel select” information can be transmitted. This is a property principally of the sensor and primarily specifies a selection of the Hall elements of the Hall sensor 222, for example which two out of, in the present case, a total of three Hall elements contained in the sensor were used. This selection of the Hall elements that is generally possible in this respect and is to be performed in the specific embodiment is performed independently by the Hall sensor 222 or the rotary measuring sensor 220, specifically such that the generated voltages of the selected Hall elements are implemented as far as possible non-simultaneously.

This ensures that the sensor can recognize the direction of rotation as well as possible from the relative temporal position of the two Hall element voltages. This “channel select” mechanism mentioned above is thus by way of example for a concrete embodiment of the concept of the disclosure; the concept of the disclosure should be understood more generally in this respect and the following embodiments in regard to a specific kind of a Hall sensor 222 or a rotary measuring sensor 220 or a specific kind of a data protocol are on no account restrictive for the concept of the disclosure that should be generally understood.

The data protocol or stipulation of a data sequence is used to define which message kind NT is sent in each case, or to define the message of a predetermined kind in accordance with the general concept of the disclosure. In the present case in the embodiment to be explained, the message of a predetermined kind 123 is a status message 124 in accordance with a data protocol 100. The message kind NT of the messages 120 of a message sequence 110 can be classified by the signal processing device 260 or suchlike evaluation unit solely on the basis of the order—defined by the data protocol 100.

Advantageously, however, the message kind NT can also be additionally or alternatively encoded in the message 120, for example in specific bits of the “word” of the messages 120. The signal processing device 260, in particular the identification unit 272, or suchlike evaluation unit 262 can then identify the message kind independently of the order.

Via the diagnostic unit 1260, diagnostic functions can be realized on the basis of the messages of a predetermined kind 123, in particular status messages 124, that are stored in the assignment memory 1240.

By way of example, a wobble fault FT of the rotary scale body 240 and/or of the rotating part 1100 can be deduced on the basis of a number of peak-to-peak messages 125 assignable in each case to a measurement feature 250. A wobble fault FT is present in particular if the rotary scale body 240 and/or the rotating part 1100 no longer rotate(s) about a rotation axis AR, but rather have/has a deviating rotation axis. Statistical methods such as for example, regression, mean value determination and the like can be employed for this purpose. Likewise, for example via defined or dynamically adaptable limit values, outliers for identifying faults F of the measurement features 250, for example mechanical faults in the tooth-valley pairing 254, a tooth fault FZ, can be determined by the diagnostic unit 1260.

Generally, it should be understood that a measure of the absolute magnitude of the voltage changes when the current measurement feature moves past the sensor is transmitted in a “peak-to-peak” message. Missing or damaged teeth, or tooth interspaces filled with abraded metal, in the course of moving past, cause a weaker magnetic field change and thus smaller voltage changes (smaller peak-to-peak value).

The rotary measuring device 200 furthermore has a rotary scale body 240, which is illustrated here merely as a detail and in an unrolled state, in which the—actually circular-arc-shaped—course of alternating tooth tips 256 and tooth valleys 258 is shown with a straight course here. The rotary scale body 240 is configured as a toothed wheel 242 with a message number A of measurement features 250, wherein the measurement features 250 in the present case are each configured as a tooth-valley pairing 254. A tooth tip 256 and an adjacent tooth valley 258 in each case together form a tooth-valley pairing 254. A measurement feature 250 can have one or more feature properties 280, which can be manifested in dimensions, temperatures or suchlike state parameters. A feature property 280 is measurable, in particular, and can advantageously allow a conclusion to be drawn about the state of the measurement feature 250.

By way of example, FIG. 1 illustrates yet another processing unit 264, which likewise uses or processes further the data of the rotary measuring device 200 on the basis of the data protocol 100. In particular, on the basis of the channel messages 122, advantageously on the basis of the time stamps of the channel messages 122, position- and/or movement-related characteristic variables can be determined such as for example, an angular pose RW, that is, rotational position, or a rotational speed RV of the rotating part 1100.

Advantageously, the rotary measuring system, as shown here in the rotary measuring sensor 220, or alternatively in the electronic control unit 700, can have an encoding unit 268 configured for encoding and/or decoding information. In this case, the encoding and/or decoding advantageously take(s) place independently of the content of the individual messages 120, but rather via the arrangement of different message kinds NT within one or more message sequences 110. In this way, information, in particular index information IX and/or useful information IY, can be encoded by the rotary measuring sensor 220 and decoded again elsewhere, for example in the electronic control unit 700.

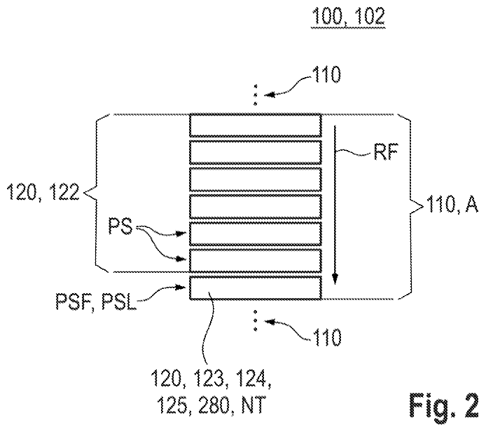

FIG. 2 schematically shows a preferred embodiment of a signal processing device with a data protocol 100 as a cyclic succession of message sequences 110, one message sequence 110 of which is illustrated in detail. The message sequence 110 of the data protocol 100 has a message number A of seven messages 120 in an order RF. Each message is situated at a sequence position PS, two of which are designated here by way of example.

The message sequence 110 has a message of a predetermined kind 123 in the form of a status message 124. The status message 124 is situated at a selection position PSF for each message sequence 110. In the present case, the last message 120 of a message sequence 110 is configured as a status message 124, that is, the selection position PSF is situated at a last sequence position PSL of the message sequence 110. The status message 124 describes a feature property 280 of the measurement feature 250 assigned to it.

In the present case, the message of a predetermined kind 123 is configured as a so-called peak-to-peak message 125 describing, in the form of a numerical value, a voltage difference in the voltage induced in the Hall sensor between the highest and lowest points of a tooth-valley pairing 254. The peak-to-peak message 125 thus characterizes an actual height difference between a tooth tip 256 and a tooth valley 258 in a measurement direction MR. Via the peak-to-peak message 125, it is thus possible to identify faults in the rotary scale body 240, for example a damaged, in particular broken-off, tooth tip 256 or a clogged tooth valley 258. Wobble or a suchlike kinematic fault of the rotary scale body 240 can also be recognized in an improved manner if a message of a predetermined kind 123, in particular a peak-to-peak message 125, is present for each measurement feature 250, in particular because such tendencies are recognized earlier even in the case of a relatively low measurement resolution. A message 120, in particular a channel message 122 or a message of a predetermined kind 123 in the form of a status message 124, is preferably configured as a 3-bit value, and can thus assume a value of between 0 and 7. In other embodiments, the message of a predetermined kind 123 can be configured differently, for example as a temperature message 126 describing a temperature T at the rotary measuring sensor 220. In other embodiments, the message 120 can be configured differently in accordance with the data protocol 100, for example as a 9-bit value.

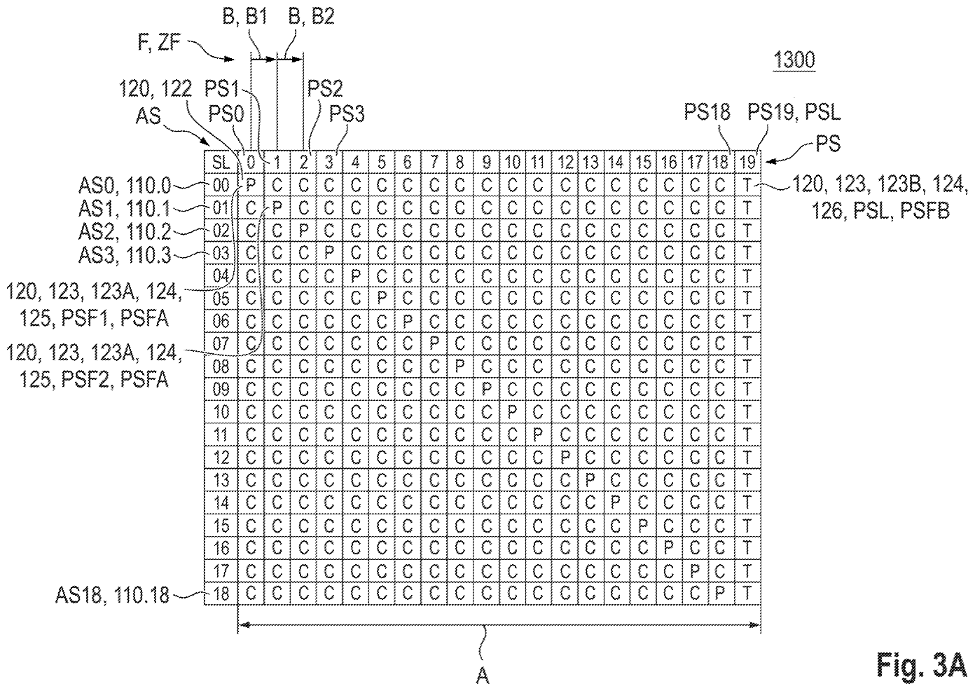

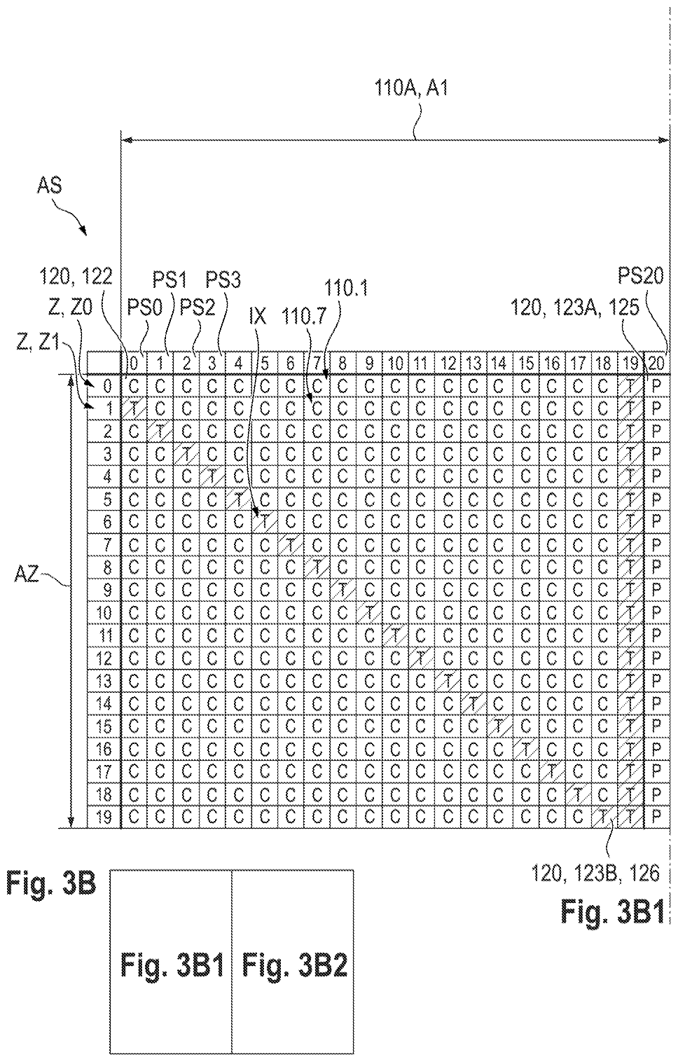

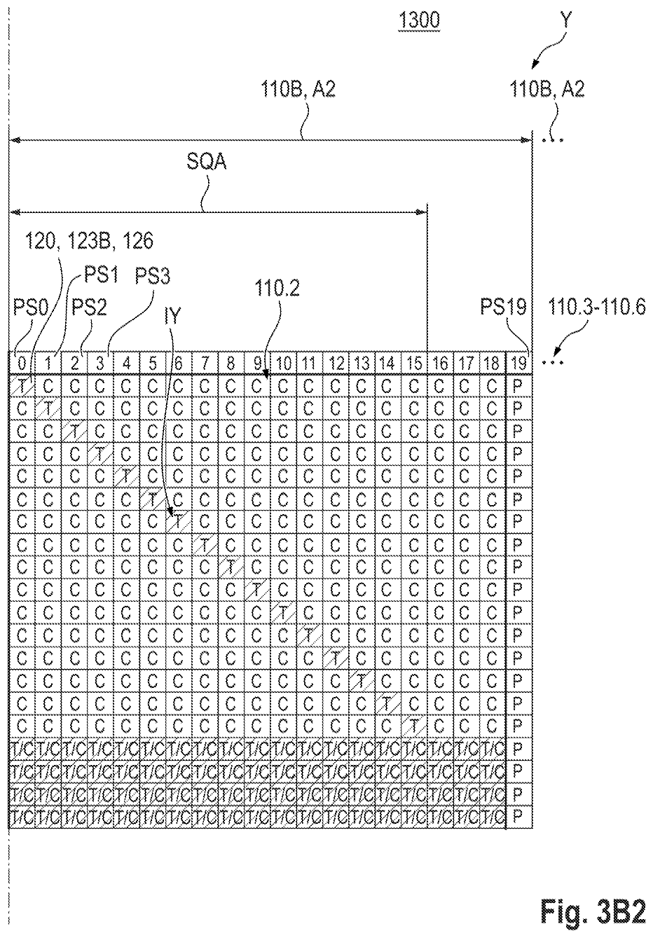

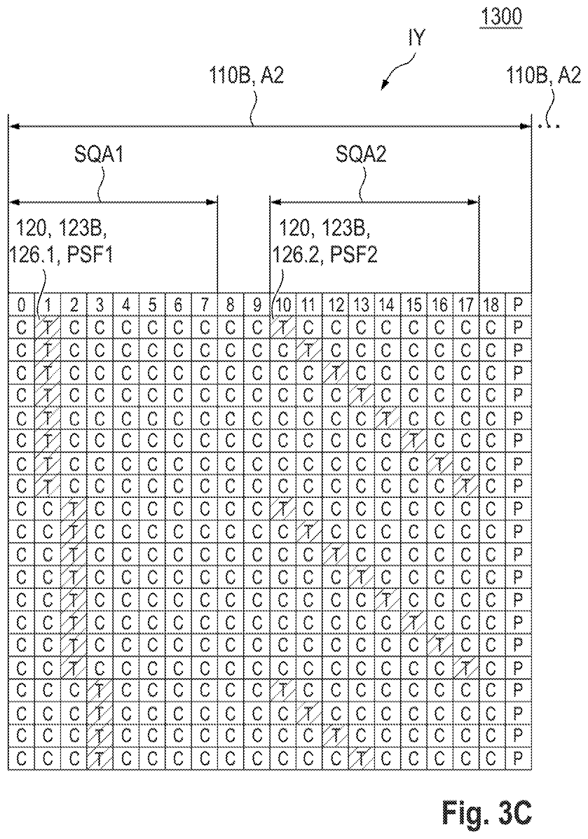

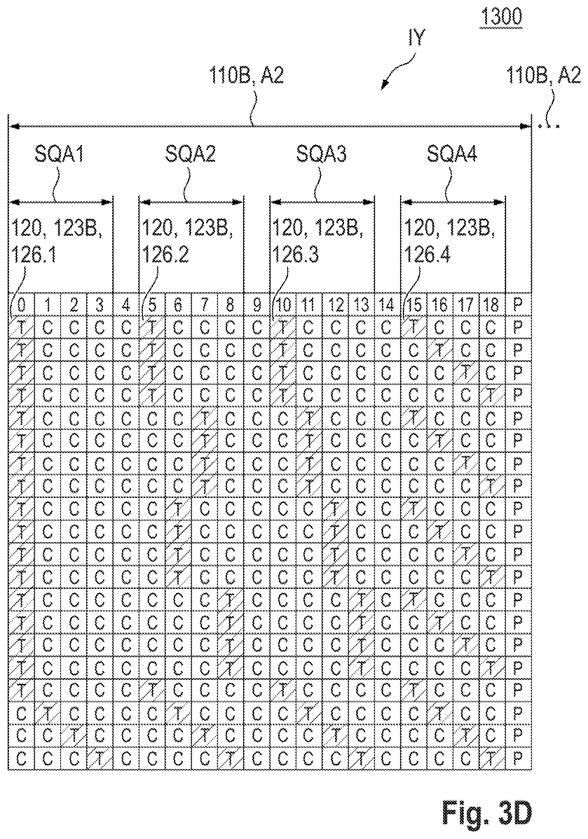

FIG. 3A shows a possible form of the provision of selection positions PSF for a preferred embodiment of a signal processing device 260. It shows a data allocation schedule 1300, also called “schedule” or “message schedule”, which describes the allocation of successive message sequences 110 with regard to the respective message kind NT. In the data allocation schedule 1300, sequence positions PS of a message sequence 110 are entered in the columns, the sequence positions ascending from left to right, and the message sequences 110 are entered in an ascending manner from top to bottom in the rows with an increasing sequence number AS. In accordance with the data allocation schedule 1300 illustrated in FIG. 3A, the message sequences 110 advantageously include a message of a predetermined kind 123 of a first type 123A, here in the form of a peak-to-peak message 125, and also a message of a predetermined kind 123 of a second type 123B, here in the form of a temperature message 126.

Selection positions PSF of a first type PSFA are provided for each message sequence 110 in accordance with a number series ZF. The number series ZF is such that the selection position PSF is shifted by an integral amount B with each ascending sequence number AS, wherein the integral amount B has the constant value 1 in the present case. For example, a first selection position PSF1 of a first type PSFA in the case of the first sequence number AS1 is situated at the zeroth sequence position PS0, that is, the first possible place of the first message sequence 110.1. In the case of the succeeding second sequence number AS2, that is, the second message sequence 110.2, the selection position PSF was increased in accordance with the integral number series ZF, such that a second selection position PSF2 of a first type PSFA now lies—moved along by one place—at the first sequence position PS1. In this way, as message sequences 110 progress, a changing allocation of the selection position PSF of a first type PSFA and hence an improved detection of the feature properties of different measurement features are advantageously effected.

Upon reaching the eighteenth sequence position PS18, here in the case of the eighteenth message sequence 110.18, the data allocation schedule 1300 is used from scratch again in the succeeding message sequence. Consequently, in the succeeding message sequence (not shown here), the selection position PSF of a first type PSFA is allocated again at the zeroth sequence position PS0. Preferably, the number series ZF begins from scratch again upon reaching the message number A or, as shown here, on account of the allocation of the last sequence position PSL, already in the case of the value A−1 (A minus 1).

Selection positions PSF of a second type PSFB are provided for each message sequence 110 in constant fashion at the last sequence position PSL, in the present case at the nineteenth sequence position PS19. In this way, the message of a predetermined kind of a second type 123B advantageously marks the end of a message sequence 110 in each case.

In other embodiments, the number series Z can be formed differently, and can be formed for example by one or more functions that provide an integral value for the selection position PSF depending on a revolution number US and/or a sequence number AS.

By virtue of the fact that each message 120 advantageously has a property identifier 180, the message kind NT of each message 120 can be recognized by signal processing means, in particular the evaluation unit 262.

FIG. 3B shows a further preferred embodiment of a data allocation schedule 1300, in particular for a data protocol 100. This data allocation schedule 1300 has both message sequences 110 configured as row change sequence 110A, and message sequences 110 configured as row intermediate sequence 110B.

Preferably, a row intermediate sequence 110B has a second message number A2, wherein a feature number MA of an assigned scale body 240 is integrally divisible by the second message number A2. By way of example, given a feature number of 120, the second message number A2 as shown here is 20. Preferably, a row change sequence 110A has a first message number A1 which is greater than the second message number A2 by the value 1. Consequently, the first message number A1 amounts to the value 21 in this example. The data allocation schedule 1300 is preferably configured such that a row change sequence 110A is followed by an intermediate sequence number Y of X−1 row intermediate sequences 110B, where X is the quotient of the feature number AM and the second message number A2. Consequently, here the quotient X is equal to 6 and the intermediate sequence number Y is equal to 5. After the last, fifth row intermediate sequence 110B, which is the sixth message sequence 110.6, the zeroth row Z0 is ended and the first row Z1 begins with a seventh message sequence 110.7 configured as a row change sequence 110A. The succession of a row change sequence 110A and the intermediate sequence number Y of X−1 row intermediate sequences 110B is repeated in accordance with the data allocation schedule 1300 until the row number AZ is reached.

In accordance with the embodiment shown, the row change sequence 110, on account of its first message number A1—which is different than the second message number A2—, has the effect that the assignment between measurement features 260 and messages 120, in particular messages of a predetermined kind 123, changes with each row Z.

In the present case, peak-to-peak messages 125, as message of a predetermined kind of a first type 123A, are always arranged at the last sequence position PS of a row change sequence 110A or a row intermediate sequence 110B, that is, here PS20 or PS19. In accordance with the embodiment shown, at least one message kind NT can furthermore advantageously be used in order to encode additional information via an individual arrangement of the messages of a predetermined kind 123. In the present case, for this purpose, temperature messages 126, as messages of a predetermined kind of a second type 123B, are individually arranged at different sequence positions PS.

By virtue of the arrangement of the messages of a predetermined kind of a second type 123B at corresponding selection positions PSF, information can thus be encoded—independently of the content of the respective messages 120. By virtue of the fact that the message kind NT of each message 120, on the basis of its property identifier 180, can be ascertained by the evaluation unit 262 or suchlike evaluation electronics, information can be encoded by patterns of channel messages 122 and messages of a predetermined kind 123. In the case of the example shown in FIG. 3B, each row intermediate sequence 110B has a respective temperature message 126. By virtue of an arrangement of the temperature message 126 at a sequence position PS in a defined sequence section SQA extending from the zeroth sequence position PS0 to the fifteenth sequence position PS15, for example 16 possibilities are available for arrangement. Consequently, 4 bits (2\hat{ }4) can be encoded per row change sequence 110B.

In an analogous manner, information can be encoded by the arrangement of temperature messages 126 in the row change sequences 110A. It has proved to be advantageous to use the information encoded in the row change sequences 110A as index information IX for the succeeding useful information IY encoded in the row intermediate sequences 110B. Via index information IX, preferably an information category can be identified, for example a fault kind or a manufacturer indication or a hardware version or a software version. Via the subsequent useful information IY, the content of the information identified by the index information IX can then be indicated, in particular by an encoded numerical value.

FIG. 3C and FIG. 3D show as excerpts in each case a further preferred embodiment of a data allocation schedule 1300, with row intermediate sequences 110B being illustrated in each case as excerpts. The embodiments shown each indicate further possibilities for the encoding of information, preferably of useful information IY. In FIG. 3C, each row intermediate sequence 110B has two messages of a predetermined kind of a second type 123B, namely a first temperature message 126.1 and a second temperature message 126.2 in the present case.

In comparison with the row intermediate sequences 110B illustrated in FIG. 3B, the data density can advantageously be increased in the embodiment illustrated in FIG. 3C. Advantageously, by virtue of the fact that in two sequence sections SQA1, SQA2 each including 8 sequence positions PS can be provided in each row intermediate sequence 110B, in each of which sequence sections a message of a predetermined kind of a second type 123B can be arranged. In this way, a number between 0 and 7 can be encoded twice, whereby 3 bits (2\hat{ }3) twice, that is, 6 bits, can be encoded per row intermediate sequence 110B.

In the embodiment of the data allocation schedule 1300 illustrated in FIG. 3D, the data density of the encoded useful information IY can advantageously be increased further. In FIG. 3D, each row intermediate sequence 110B has four messages of a predetermined kind of a second type 123B, namely a first to fourth temperature message 126.1, 126.2, 126.3, 126.4 in the present case. Advantageously, four sequence sections SQA1, SQA2, SQA3, SQA4 each including four sequence positions PS can be provided in each row intermediate sequence 110B, wherein a message of a predetermined kind of a second type 123B can be arranged in each sequence section. In this way, a number between 0 and 3 can be encoded four times, whereby 2 bits four times, that is, 8 bits, can be encoded per row intermediate sequence 110B.

The extent and the data density of the encoded useful information IY can advantageously be determined by the definition of a second message number A2 of a suitable number and length of sequence sections SQA. In an analogous manner, the extent and the data density of the encoded index information IX can advantageously be determined by the definition of a first message number A1 of a suitable number and length of sequence sections SQA. Depending on the extent and/or data density, information in the form of numbers, for example integral codes or numerical values, or else in text form can be encoded and decoded.

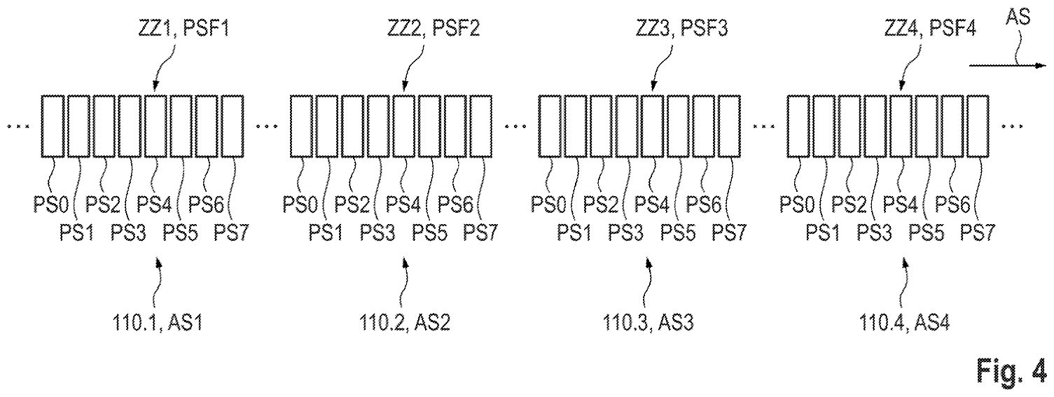

FIG. 4 shows a further possible form of the provision of selection positions PSF for a further preferred embodiment of a signal processing device 260. In accordance with this embodiment, the provision for each message sequence 110 is effected in accordance with a randomly generated random number ZZ. The random number ZZ can assume an integral value within a defined number range. The number range is advantageously defined by the message number A. Moreover, the number range can be adapted in other embodiments (not shown here), for example—as in the embodiment described above—can be formed by the message number A reduced by the value 1 in order to accommodate a message of a predetermined kind of a second type 123B with a constant selection position PSF in the message sequence 110.

In the present case, by way of example, four message sequences 110.1, 110.2, 110.3, 110.4 are shown, which each have a selection position PSF1, PSF2, PSF3, PSF4 defined randomly by way of a random number ZZ1, ZZ2, ZZ3, ZZ4 for a message of a predetermined kind 123. The embodiment shown here can advantageously be modified in such a way that it provides a message of a predetermined kind both of a first type 123a and of a second type 123B, wherein the message of a predetermined kind of a first type 123A has a selection position PSF determined by way of a random number ZZ and the message of a predetermined kind of a second type 123B has a constant selection position PSF, analogously to the embodiment shown in FIG. 3A.

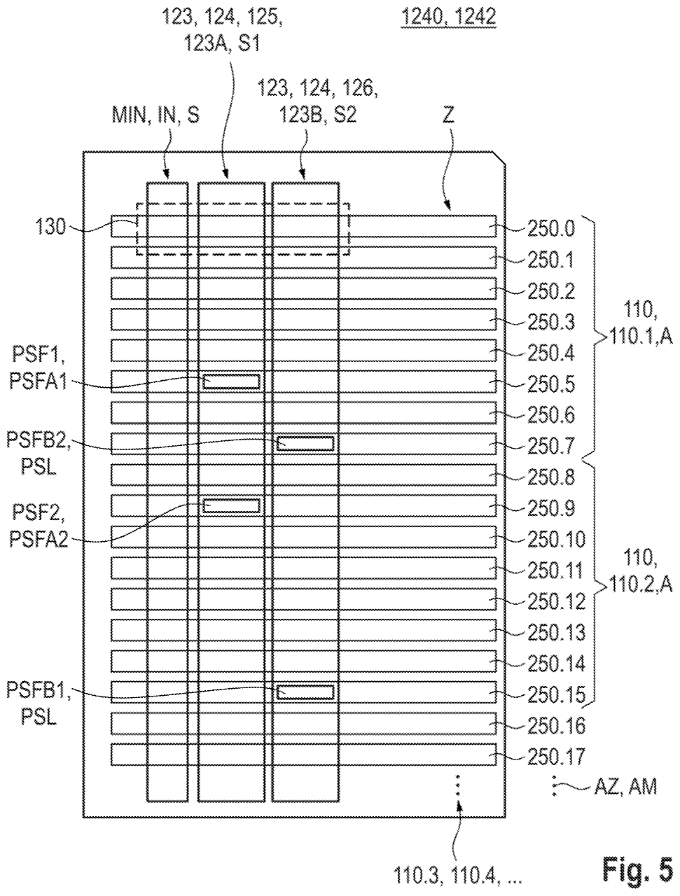

FIG. 5 schematically shows an assignment memory 1240 with an assignment table 1242. In this case, the assignment table 1242 describes in particular the structure of a database or memory according to which the messages 120 provided by the rotary measuring device 200 in accordance with the data protocol 100 are stored and are retrievable. An assignment memory 1240 is configured in particular for storing messages of a predetermined kind 123, and in this way enables the messages of a predetermined kind 123 to be kept available across measurement cycles, in particular for analysis and diagnostic purposes. A measurement cycle within the meaning of this description includes the provision of an individual message sequence 110.

In the present case, the assignment table 1242 has a row number AZ of rows Z which corresponds to the feature number AM. An assignment of values, in particular of status messages 124, to an individual measurement feature 250 is thus possible. In particular, each row Z is numbered with a feature index MIN for the purpose of assignment to a measurement feature 250. In the present case, the first fifteen rows Z for the first fifteen measurement features 250.1 to 250.15 are illustrated by way of example. By way of example, the assignment memory 1240 and the assignment table 1242 are illustrated here for the embodiment of a data protocol 100 as shown in FIG. 2, with a first message sequence 110.1 and a succeeding second message sequence 110.2. In this case, the first seven rows are to be assigned to a first message sequence 110.1, and the following seven rows to a second message sequence 110.2. The fifteenth row assigned to the measurement feature 250.16 thus forms the beginning, that is, the first message, of a third message sequence 110.3. For each message kind NT of messages of a predetermined kind 123, it is possible to provide a column S in the assignment table 1242, this being in the present case a first column S1 for the message of a predetermined kind of a first type 123A configured as a peak-to-peak message 125, and a second column S2 for the message of a predetermined kind of a second type 123B configured as a temperature message 126. During operation of the rotary measuring device 200, therefore, gradually, in particular by an assignment unit 1200, the messages of a predetermined kind 123 are stored in accordance with their message kind NT in the corresponding column S1, S2. In particular, the channel messages 122 are not considered in the course of storage. With each measurement cycle, that is, with each message sequence 110, at least one further value of a message of a predetermined kind 123 is thus included in the assignment table 1242. Alternatively or additionally, the row number AZ can be some other number that is different than the feature number AM. As an alternative or in addition to the feature index MIN, each row Z can have an index IN for the assignment of each row Z in the assignment table 1242. Advantageously, a value tuple 130 is stored in each row Z.

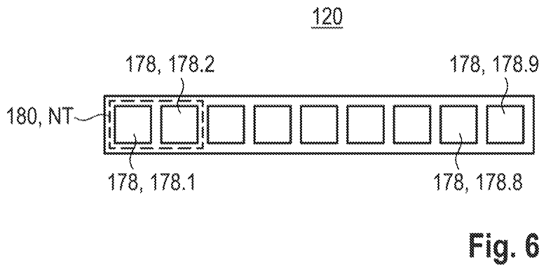

FIG. 6 schematically shows an advantageous construction of a message 120. A message 120 is advantageously constructed by a number of message bits 178. Preferably, each message 120 has the same structure, in particular the same number of message bits 178. In the present case, the message 120 has a number of nine message bits 178, which are correspondingly numbered from a first message bit 178.1 to a ninth message bit 178.9. This is therefore a 9-bit message. In the case of the message 120 shown here, the first message bit 178.1 and the second message bit 178.2 advantageously form a property identifier 180, via which the message kind NT of a message 120 can advantageously be identified. In this way, via the property identifier 180, it is advantageously possible to indicate whether the message 120 is a channel message 122, or a message of a predetermined kind 123, such as for example, a peak-to-peak message 125 or a temperature message 126. In other embodiments of signal processing devices 260, the construction of a message 120 can be configured differently, in particular can have more or fewer message bits 178, or can have a property identifier 180 elsewhere in the message 120.

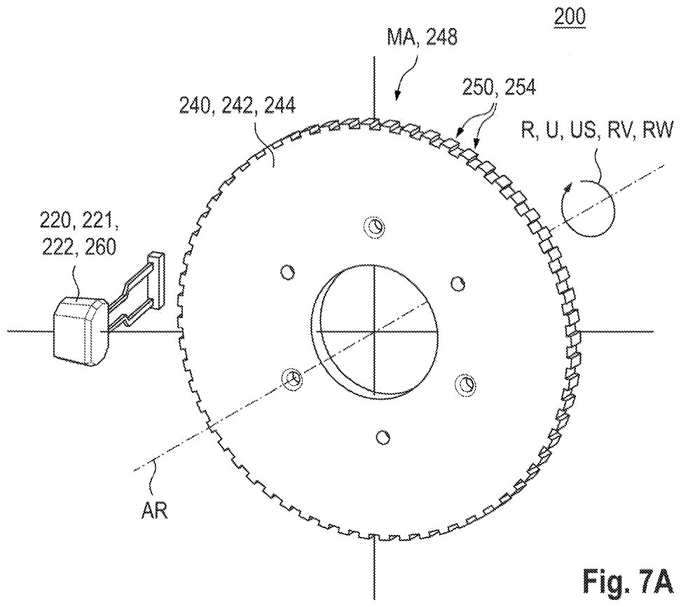

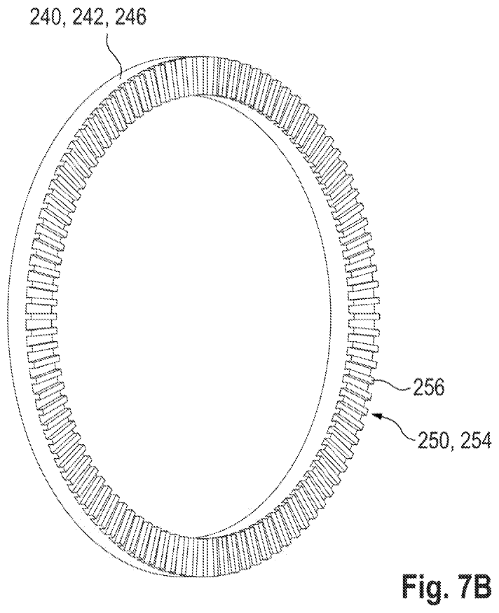

FIG. 7A shows a perspective view of a rotary measuring device 200 in accordance with the second aspect of the disclosure. The rotary scale body 240 is configured as a toothed wheel 242 in the form of a spur gear 244, which has a feature number AM of measurement features 250 configured as tooth-valley pairing 254 and arranged equidistantly along a circular path 248 on the toothed wheel 242. The rotary scale body 240 is connected to a rotating part 1100 (not illustrated here) in particular for conjoint rotation therewith, in order to metrologically detect a rotary movement R of the rotary scale body 240—and thus of the rotating part 1100. The larger the feature number A, the smaller the metrologically detectable sections of the rotary scale body 240. In this case, a revolution U corresponds to a movement of the rotary scale body 240 by 360° around the rotation axis AR. Given a feature number MA of 60, a measurement feature 250 thus extends over a circle segment of 6°. The larger the feature number MA, the more accurately the rotary movement R, in particular a rotational speed RV or angular pose RW, can be detected. A toothed wheel 242 within the meaning of the disclosure encompasses any bodies having in particular a rotationally symmetrical main body and a number of geometric features which vary the distance with respect to a rotary measuring sensor 220 in relation to the measurement direction MR during a rotary movement R. In this case, it is sufficient for measurement purposes in particular if a tooth tip is of rectangular configuration, that is, is perpendicularly rising and falling in a tangential direction as shown here in FIG. 7A. The rotary measuring sensor 220 includes a measurement value pickup 221 in the form of a Hall sensor 222. In the preferred embodiment shown here, the rotary measuring sensor 220 advantageously includes the signal processing device 260.

Moreover, other forms of toothed wheels 242 are possible, for example a crown wheel 246 having tooth tips 256 formed in an axial direction, as shown here by way of example in FIG. 7B.

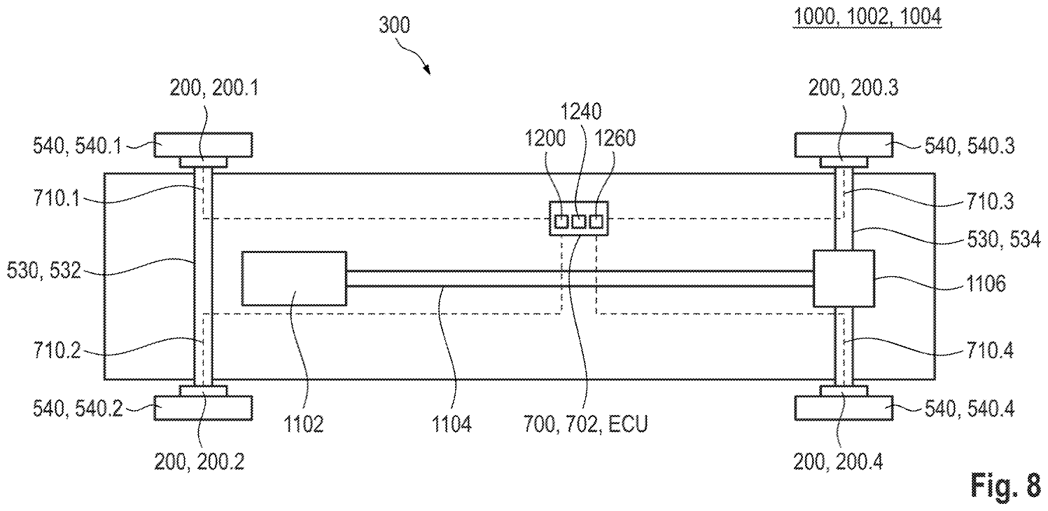

FIG. 8 shows highly schematically a vehicle 1000 including a rotary measuring system 300 including a number of four rotary measuring devices 200 in accordance with the second aspect of the disclosure. The vehicle 1000, as shown here, can be configured as an automobile 1002. In other embodiments, the vehicle 1000 can be configured differently, for example as a commercial vehicle 1004. The vehicle has two axles 530, namely a front axle 532 and a rear axle 534. The rear axle 534 is driven by a drive 1102 via a drive shaft 1104 and a differential 1106. Two wheels 540 are secured to each axle 530. A first wheel 540.1 with a first rotary measuring device 200.1 and a second wheel 540.2 with a second rotary measuring device 200.2 are arranged on the front axle 532, and a third wheel 540.3 with a third rotary measuring device 200.3 and a fourth wheel 540.4 with a fourth rotary measuring device 200.4 are arranged on the rear axle 534. The respective wheel 540 thus constitutes the rotating part 1100 for the assigned rotary measuring device 200. The first rotary measuring device 200.1 is connected to an electronic control unit 700 in the form of a vehicle control unit 702 in a signal-carrying manner via a first rotary measuring signal line 710.1. The electronic control unit 700 has an assignment unit 1200, an assignment memory 1240 and a diagnostic unit 1260. In an analogous manner, the other rotary measuring devices 200.2, 200.3, 200.4 are each connected to the electronic control unit 700 in a signal-carrying manner via a rotary measuring signal line 710.2, 710.3, 710.4. In embodiments, the electronic signal processing device 260 or the assignment unit 1200, the assignment memory 1240 or the diagnostic unit 1260 can be arranged as a hardware or software module in a different electronic control unit.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

100 Data protocol
110 Message sequence
110.0-110.18 Zeroth to eighteenth message sequence
110A Row change sequence
110B Row intermediate sequence
120 Message
122 Channel message
123 Message of a predetermined kind
123A Message of a predetermined kind of a first type
123B Message of a predetermined kind of a second type
124 Status message
125 Peak-to-peak message
126 Temperature message
130 Value tuple
178 Message bit
178.1-178.9 First to ninth message bit
180 Property identifier
200 Rotary measuring device
220 Rotary measuring sensor
221 Measurement value pickup
222 Hall sensor
240 Rotary scale body
242 Toothed wheel
244 Spur gear
246 Crown wheel
248 Circular path
250 Measurement feature
254 Tooth-valley pairing
256 Tooth tip
258 Tooth valley
259 Tooth flank
260 Signal processing device
262 Evaluation unit
264 Further processing unit
268 Encoding unit
272 Identification unit
280 Feature property
200.1-200.4 First to fourth rotary measuring device
250.1-250.17 First to seventeenth measurement feature
300 Rotary measuring system
530 Axle
532 Front axle
534 Rear axle
540 Wheel
540.1-540.4 First to fourth wheel
700 Electronic control unit
702 Vehicle control unit
710.1-710.4 First to fourth rotary measuring signal line
1000 Vehicle
1002 Automobile
1004 Commercial vehicle
1100 Rotating part
1102 Drive
1104 Drive shaft
1106 Differential
1200 Assignment unit
1240 Assignment memory
1242 Assignment table
1260 Diagnostic unit
1300 Data allocation schedule
A Message number
A1 First message number, message number of the row change sequence
A2 Second message number, message number of the row intermediate sequence
AM Feature number
AR Rotation axis
AS Sequence number
AZ Row number
B Amount
F Fault
FT Wobble fault
FZ Tooth fault
IN Index
IX Index information
IY Useful information
MA Feature number
MIN Feature index
MR Measurement direction
NT Message kind
PS Sequence position
PSF Selection position
PSFA Message of a predetermined kind of a first type
PSFB Message of a predetermined kind of a second type
PSL Last sequence position
R Rotary movement
RF Order
RV Rotational speed
RW Angular pose
S Column
SQA Sequence section
SQA1-4 First to fourth sequence section
U Revolutions
UM Measurement voltage
US Revolution number
X Quotient of feature number and second message number
Y Intermediate sequence number
ZF Number series
ZZ Random number

1. A signal processing device for a rotary measuring device having a rotary measuring sensor and a rotary scale body having a feature number of measurement features, comprising:
a non-transitory computer readable medium having program code stored thereon;
said program code being configured, when executed by a processor, to cause the signal processing device to provide a plurality of chronologically successive message sequences;
each of said message sequences having a message number of successive messages such that chronologically successive messages are chronologically successively assigned to locally adjacent measurement features, wherein the measurement features interact with the rotary measuring sensor, and each of the messages is provided in a message kind selected from a predetermined number of message kinds;
the message of the successive messages arranged at a selection position of the message sequence being a message of a predetermined kind which describes a feature property of the assigned measurement features;
the successive message sequences having a first message sequence and a second message sequence; and,
the signal processing device being configured to select the selection position for the message sequences such that a first selection position for a first message of the predetermined kind is provided for the first message sequence, and a second selection position for a second message of the same predetermined kind is provided for the second message sequence.

2. The signal processing device of claim 1, wherein the signal processing device is configured to select the selection position for each of the plurality of message sequences.

3. The signal processing device of claim 1, wherein the message of the predetermined kind is a status message.

4. The signal processing device of claim 1, wherein the message of the predetermined kind is a peak-to-peak message describing an amplitude of a local measurement signal change of the rotary measuring sensor, or a temperature message describing a temperature at the rotary measuring sensor.

5. The signal processing device of claim 1 further comprising an identification unit configured to recognize the message kind of the message on the basis of a property identifier.

6. The signal processing device of claim 5, wherein the property identifier is formed by two message bits of each message.

7. The signal processing device of claim 5, wherein the property identifier is formed by a first two message bits of each message.

8. The signal processing device of claim 1, wherein the signal processing device is configured to select the selection position as a function of at least one of a revolution of the rotary scale body and the message sequences.

9. The signal processing device of claim 8, wherein the signal processing device is configured to provide the selection position for each revolution number of revolutions of the rotary scale body or for each sequence number of the message sequences, wherein the first selection position and the second selection position are part of an integral number series.

10. The signal processing device of claim 9, wherein the signal processing device is configured to adapt the number series by an integral amount for at least one of each revolution number and sequence number.

11. The signal processing device of claim 9, wherein the signal processing device is configured to provide a sequence position ascending integrally with at least one of each revolution number and sequence number as the selection position.

12. The signal processing device of claim 9, wherein the signal processing device is configured to select a randomly generated random number as the selection position, wherein:
a first random number is to be generated for the first selection position and a second random number is to be generated for the second selection position; and,
the first and second random number can assume an integral value between a value zero and a value of the message number.

13. The signal processing device of claim 1, wherein the message sequences include a first message of the predetermined kind of a first type with the selection position of a first position type and a second message of the predetermined kind of a second type with the second selection position of a second position type.

14. The signal processing device of claim 13, wherein the selection position of the second position type is arranged at a last sequence position of each message sequence, wherein the second message of the predetermined kind indicates an end of each message sequence on a basis of a property identifier.

15. The signal processing device of claim 1 further comprising:
an encoding unit configured for at least one of encoding and decoding information; and,
the encoding being effected by an arrangement of at least one message of the predetermined kind at a sequence position in a message sequence.

16. The signal processing device of claim 15, wherein the information is at least one of index information and useful information.

17. The signal processing device of claim 15, wherein the at least one message of the predetermined kind is a temperature message.

18. A rotary measuring device for a rotating part, the rotary measurement device comprising:
a rotary measuring sensor having a measurement value pickup;
a rotary scale body having a feature number of measurement features;
a signal processing device connected to the measurement value pickup in a signal-carrying manner;
said signal processing device being configured to provide a plurality of chronologically successive message sequences;
each of said message sequences having a message number of successive messages such that chronologically successive messages are chronologically successively assigned to locally adjacent measurement features, wherein the measurement features interact with the rotary measuring sensor, and each of the messages is provided in a message kind selected from a predetermined number of message kinds;
the message of the successive messages arranged at a selection position of the message sequences being a message of a predetermined kind which describes a feature property of the assigned measurement features;
the successive message sequences having a first message sequence and a second message sequence; and,
said signal processing device being configured to select the selection position for the message sequences such that a first selection position for a first message of the predetermined kind is provided for the first message sequence, and a second selection position for a second message of the same predetermined kind is provided for the second message sequence.

19. The rotary measuring device of claim 18, wherein the measurement features are arranged at least one of along a circular path and equidistantly.

20. The rotary measuring device of claim 18, wherein the rotary scale body is configured as a toothed wheel.

21. The rotary measuring device of claim 18, wherein the rotary scale body is a toothed wheel and a measurement feature is a tooth tip, a tooth valley, or a tooth-valley pairing including the tooth tip and the tooth valley.

22. The rotary measuring device of claim 18, wherein the rotating part is a shaft of a vehicle or a wheel of the vehicle.

23. A rotary measuring system comprising:
at least one rotary measuring device having a rotary measuring sensor including a measurement value pickup;
said at least one rotary measuring device further having a rotary scale body having a feature number of measurement features;
said at least one rotary measuring device further having a signal processing device connected to the measurement value pickup in a signal-carrying manner;
said signal processing device being configured to provide a plurality of chronologically successive message sequences;
each of said message sequences having a message number of successive messages such that chronologically successive messages are chronologically successively assigned to locally adjacent measurement features, wherein the measurement features interact with the rotary measuring sensor, and each of the messages is provided in a message kind selected from a predetermined number of message kinds;
the message of the successive messages arranged at a selection position of the message sequence being a message of a predetermined kind which describes a feature property of the assigned measurement features;
the successive message sequences having a first message sequence and a second message sequence;
said signal processing device being configured to select the selection position for the message sequences such that a first selection position for a first message of the predetermined kind is provided for the first message sequence, and a second selection position for a second message of the same predetermined kind is provided for the second message sequence; and,
an assignment unit configured to assign the message of the predetermined kind arranged at the selection position of the message sequences, in particular a status message of a message sequence, to a measurement feature.

24. The rotary measuring system of claim 23, wherein the message is a status message of the message sequence.

25. The rotary measuring system of claim 23 further comprising at least one of an assignment memory and an assignment table, which is configured to store in each case an assigned message of the predetermined kind, for one or more measurement features.

26. The rotary measuring system of claim 23 further comprising at least one of an assignment memory and an assignment table, which is configured to store a value tuple for one or more measurement features.

27. The rotary measuring system of claim 23 further comprising a diagnostic unit configured to recognize at least one of a fault state and an operating state depending on the at least one measurement feature assigned to the message of the predetermined kind.

28. The rotary measuring system of claim 23 further comprising a diagnostic unit configured to recognize at least one of a fault state and an operating state depending on at least one value tuple.

29. A vehicle comprising the signal processing device of claim 1.

30. A vehicle comprising the rotary measuring device of claim 18.

31. A vehicle comprising the rotary measuring system of claim 23.
